(19) United States
(12) Patent Application Publication
(10) Pub. No.: US 2018/0231090 A1
(43) Pub. Date: Aug. 16, 2018

(54) SYSTEMS AND METHODS FOR A TUNED MASS DAMPER IN MEMS RESONATORS

(71) Applicant: Honeywell International Inc., Morris Plains, NJ (US)

(72) Inventors: Markus Hans Gnerlich, Plymouth, MN (US); Burgess R. Johnson, Bloomington, MN (US); Kevin V. Christ, Plymouth, MN (US)

(21) Appl. No.: 15/466,774

(22) Filed: Mar. 22, 2017

Related U.S. Application Data
(60) Provisional application No. 62/342,125, filed on May 26, 2016.

(51) Int. Cl. F16F 7/10; G01C 19/5726

(52) U.S. Cl. CPC F16F 7/1005; G01C 19/5726

(57) ABSTRACT

Systems and methods for a tuned mass damper in mems resonators are provided. In certain implementations, a system for suppressing undesirable vibration modes comprises a micro-electrical mechanical system (MEMS) resonator, the MEMS resonator comprising two or more proof masses, comprising; and a plurality of anchors, wherein proof masses in the two or more proof masses are connected to the plurality of anchors through a plurality of flexures. The system also further comprises a substrate, wherein the MEMS resonator is mounted to the substrate through the plurality of anchors; and one or more tuned mass dampers configured to counter-act the undesirable vibration modes in the substrate and the MEMS resonator.

### CROSS REFERENCE TO RELATED APPLICATIONS

This application claims the benefit of U.S. Provisional Patent Application Ser. No. 62/342,125, filed on May 26, 2016, which is hereby incorporated herein by reference.

### STATEMENT REGARDING FEDERALLY SPONSORED RESEARCH OR DEVELOPMENT

This invention was made with Government support under Government Contract Number HR0011-16-9-0001 awarded by DARPA. The Government has certain rights in the invention.

### BACKGROUND

Ideally, certain MEMS sensors, including vibratory MEMS sensors such as MEMS gyroscopes, would produce zero net vibration external to the sensor mechanism. However, imperfections may be introduced during fabrication of the MEMS sensor and the mounting of the MEMS sensor to the sensor package. For example, imperfections may include etch variations across a wafer which may introduce a degree of non-symmetry in the vibrating masses. The non-symmetry may produce a net external vibration. Since the mounting fixture and sensor mechanism are mechanically coupled, a non-symmetry in the mounting fixture may transform a portion of the linear vibration into a measureable rotational component. This additional rotational component introduces a non-compensatable bias into the gyro output.

### SUMMARY

Systems and methods for a tuned mass damper in mems resonators are provided. In certain implementations, a system for suppressing undesirable vibration modes comprises a micro-electrical mechanical system (MEMS) resonator, the MEMS resonator comprising two or more proof masses, comprising; and a plurality of anchors, wherein proof masses in the two or more proof masses are connected to the plurality of anchors through a plurality of flexures. The system also further comprises a substrate, wherein the MEMS resonator is mounted to the substrate through the plurality of anchors; and one or more tuned mass dampers configured to counter-act the undesirable vibration modes in the substrate and the MEMS resonator.

### DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1C are block diagrams illustrating MEMS sensors having a tuned mass damper according to embodiments described herein;

FIG. 2 is a diagram illustrating the proof masses of a MEMS sensor in conjunction with a tuned mass damper according to one or more embodiments described herein;

FIG. 3 is a diagram illustrating the proof masses of a MEMS sensor in conjunction with multiple tuned mass dampers configured to suppress rotational vibrations according to one or more embodiments described herein;

FIG. 4 is a diagram illustrating the proof masses of a MEMS sensor in conjunction with multiple tuned mass dampers according to one or more embodiments described herein;

FIG. 5 is a flow diagram illustrating a method for suppressing undesirable vibration modes according to one or more embodiments described herein.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

To remove vibrations caused by imperfections in fabrication, a tuned mass damper may be used to reduce harmonic vibrations caused by the imperfections. A tuned mass damper (TMD) consists of an additional mass and spring connected to a larger assembly. The tuned mass damper has the net effect of reducing the harmonic vibration of the assembly at one or more frequencies. The frequency of the mass/spring system of the TMD is tuned to a frequency to reduce harmonic vibration by naturally resonating out of phase with the main assembly. The amplitude of the vibration of the smaller TMD is relatively large and the combined inertia of the TMD system results in a lower vibration amplitude of the larger assembly. In at least one implementation, the TMD may be used in a dual mass tuning fork vibratory micro-electrical mechanical systems (MEMS) gyroscope where the tuned mass damper may be placed between two primary vibrating masses. As there may be some asymmetry between the physical characteristics of the two primary masses in the larger assembly, the tuned mass damper, placed in between the two primary masses may suppress undesirable side-to-side vibration that is transmitted to the gyroscope package/chassis, while antisymmetric tuning fork vibration may be unaffected. Further, the use of a tuned mass damper may be used to suppress the motion of multiple gyro modes that are excited by imperfections in the tuning fork mode motion along the x-axis, for example, quadrature sense mode motion, symmetric z-axis motion, symmetric y-axis motion, etc. The TMD may be configured to have damping combs. Alternatively, the TMD may be configured without damping combs.

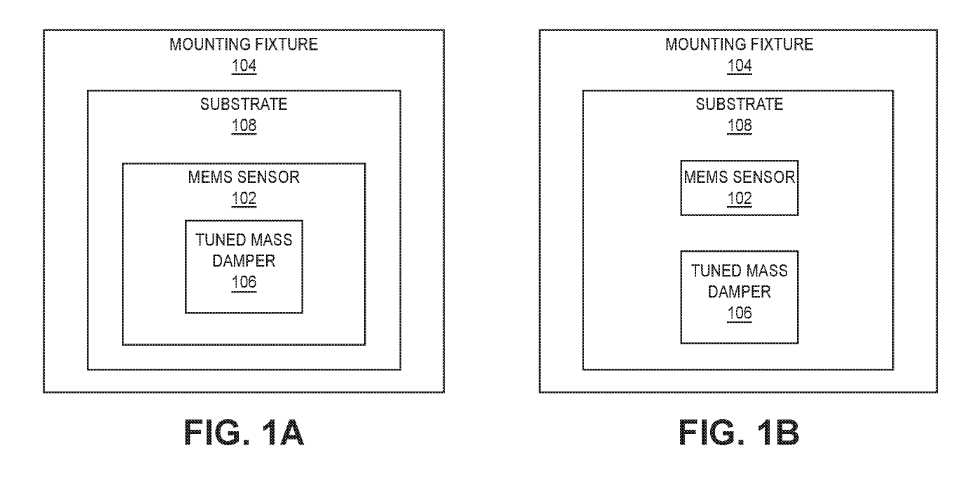

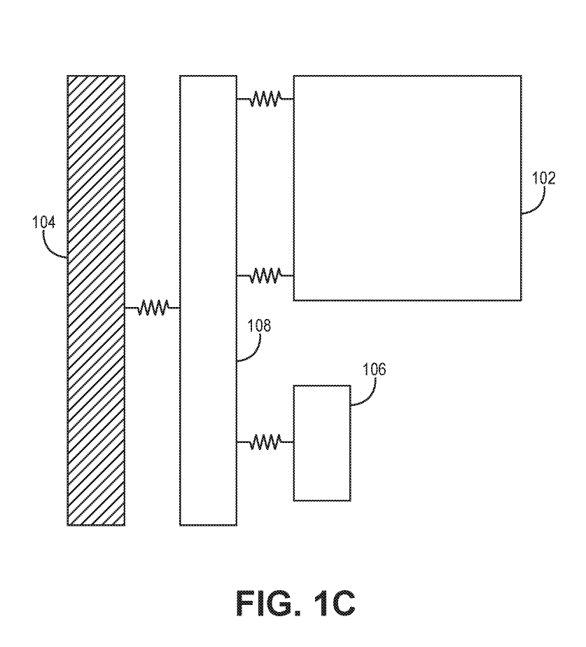

FIG. 1A is a block diagram of a MEMS sensor mounting fixture 104 having a tuned mass damper 106 as part of the MEMS sensor 102. The MEMS sensor 102 may be a dual mass tuning fork vibratory MEMS gyroscope, an out of plane gyroscope, in plane gyroscopes, vibrating beam accelerometers, or other MEMS sensors or actuators where the output of a structure is dependent on a vibrating structure. When there are fabrication imperfections in the MEMS sensor 102 or imperfections with the mounting of the MEMS sensor 102 to a substrate 108 or the mounting of the substrate to the mounting fixture 104, unintended vibrations in the MEMS sensor 102 and mounting fixture 104 may be created. The unintended vibrations may introduce a non-compensatable bias into the sensor output. As shown in FIG. 1A, a tuned mass damper 106 may be incorporated as part of the MEMS sensor 102. The flexures connecting the tuned mass damper 106 may be tuned such that the tuned mass damper 106 is able to counter-act vibrations caused by the imperfections that may cause spurious signals in the output from the MEMS sensor 102. In at least one implementation, the tuned mass damper 106 is a passive tuned mass damper, however, in alternative implementations, the tuned mass damper 106 may be a mass that is actively driven by a force that is based on the output of a control loop designed to suppress undesired vibrations. Alternatively, the TMD may have a damping mechanism attached thereto, such that the TMD may absorb vibration energy. FIG. 1B illustrates a different implementation of a tuned mass damper 106, where the tuned mass damper 106 is not fabricated as part of the MEMS sensor 102 but rather mounted next to the MEMS sensor 102 on the substrate 108. For example, FIG. 1C provides a side view of a tuned mass damper 106 mounted to the substrate 108 as shown in FIG. 1B. As illustrated, the substrate 108 may be a silicon or glass substrate that is bump bonded to the mounting fixture 104. Alternatively, the mounting fixture 104 may be connected to the substrate 108 through one or more flexures. Both the proof masses of the MEMS sensor 102 and the tuned mass damper 106 may then be free standing MEMS structures connected to the substrate 108.

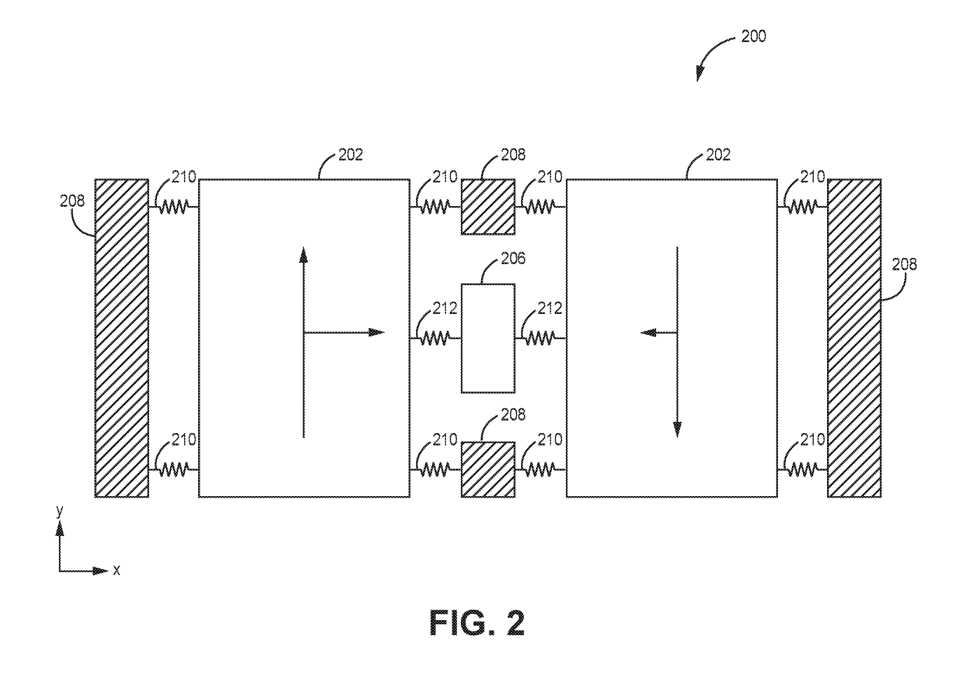

FIG. 2 is a block diagram illustrating one implementation for a MEMS sensor 200, where the MEMS sensor 200 includes a dual mass tuning fork gyroscope. As illustrated, the dual mass tuning fork gyroscope may include a pair of proof masses 202. Each proof mass 202 may be a planar member defining two major surfaces on reverse sides of their respective proof masses 202. Further, in some implementations, each proof mass may have combs mounted to at least two opposite edges. One of the combs may have tines that are interleaved with a comb of a respective in-plane drive electrode. Alternatively, the combs may be interleaved with drive electrodes disposed out-of-plane from the proof masses 202, as described in U.S. Pat. No. 7,036,373, which is titled “MEMS Gyroscope with Horizontally Oriented Drive Electrodes” and is incorporated herein by reference. A second of the combs of each proof mass 202 may be interleaved with a comb of an in-plane motor pickoff electrode.

In further implementations, a pair of upper sense electrodes may be disposed out-of-plane from the proof masses 202. Likewise a pair of lower sense electrodes may be disposed out-of-plane from the proof masses 202 on an opposite side of the proof mass 202 from the upper sense electrodes. Alternatively, for an out-of-plane MEMS gyroscope, the sense electrodes may consist of sense combs disposed in-plane from the proof masses 202 and interleaved with sense combs attached to the proof masses 202. Both the upper and lower sense electrodes are proximate to a respective side of the proof masses 202. Also, each of the proof masses 202 is suspended by support flexures 210 permitting movement of the proof masses 202 relative to the in-plane motor pickoff electrode and the out-of-plane sense electrodes or in-plane sense combs. Further, to conter-act vibrations due to imperfections in the fabrication and mounting of the MEMS sensor 200, each of the proof masses 202 may be connected to a tuned mass damper 206. For example, each of the proof masses 202 may be connected to opposite sides of the tuned mass damper 206 through flexures 212 that extend between the tuned mass damper 206 and the proof masses 202. Further, the proof masses 202 are supported by the support flexures 210 that connect to anchors 208. The anchors 208 are mounted to a supporting substrate.

In certain embodiments, during operation, respective AC drive signals are applied to drive electrodes to induce in-plane motion on the respective proof masses 202. The in-plane motion of the respective proof masses 202 induces an in-plane signal through the in-plane motor pickoff electrode. In at least one implementation, control electronics may be coupled to the motor pickoff electrode and configured to process the in-plane signal to adjust the AC drive signals to maintain a desired magnitude and frequency for the in-plane motion of the proof masses 202.

Respective voltages may be applied between the sense electrodes and their corresponding proof masses 202 in order to sense out-of-plane motion of the proof masses 202 for an in-plane MEMS gyroscope, or in-plane motion for an out-of-plane MEMS gyroscope. For example, at a given moment in time a positive voltage can be applied between the proof masses 202 and a respective upper sense electrode proximate to a first side of the proof masses 202 and a negative voltage can be applied between the proof masses 202 and a respective lower sense electrode proximate a second side of the proof masses 202. The voltage difference between the upper and lower sense electrodes and the respective proof masses 202 may induce an out-of-plane signal for the proof masses 202 when the proof masses 202 move out-of-plane. Further control electronics may be coupled to the MEMS sensor 200 and may be configured to process the out-of-plane signal to determine a rotation rate for the proof masses 202 among other things. As the proof masses 202 are both coupled to a tuned mass damper 206, the tuned mass damper 206 may be tuned to counter-act asymmetric vibrations due to imperfections in fabrication and mounting that may affect the rotation rate.

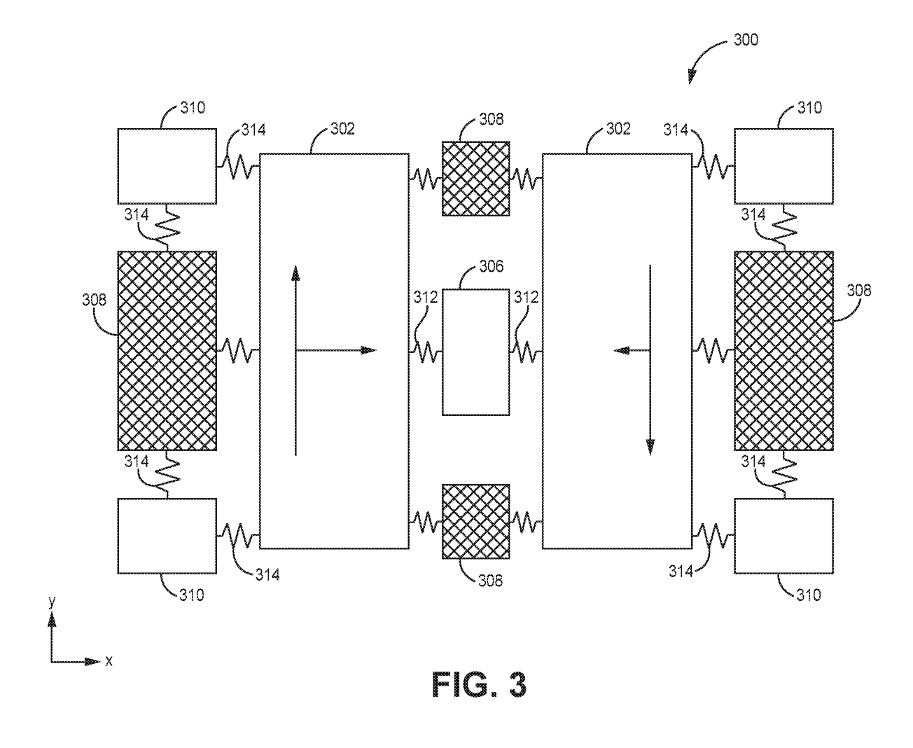

FIG. 3 is a diagram illustrating a MEMS sensor 300 having multiple tuned mass dampers 306 and 310. The tuned mass damper 306 is similar to the tuned mass damper 206 described above with regards to FIG. 2. Further, the MEMS sensor 300 may also include tuned mass dampers 310. In contrast to tuned mass damper 306, tuned mass dampers 310 are located at positions within the MEMS sensor 300 such that they are able to counter-act rotational vibrations due to imperfections in the MEMS sensor 300. For example, the tuned mass dampers 310 may be placed around the perimeter of the MEMS sensor such that they are able to vibrate tangentially to the rotation vibrations of the MEMS sensor 300. Accordingly, the proof masses 302 are connected to the tuned mass damper 306 through flexures 312 and tuned mass dampers 310 through flexures 314, where the tuned mass dampers 310 may or may not be coupled to anchors 308. Thus, the tuned mass dampers 306 and 310 may suppress undesirable mechanical modes that may negatively impact performance of a gyro, even if the undesirable mode is created from sources other than the interaction of the MEMS sensor with a chassis.

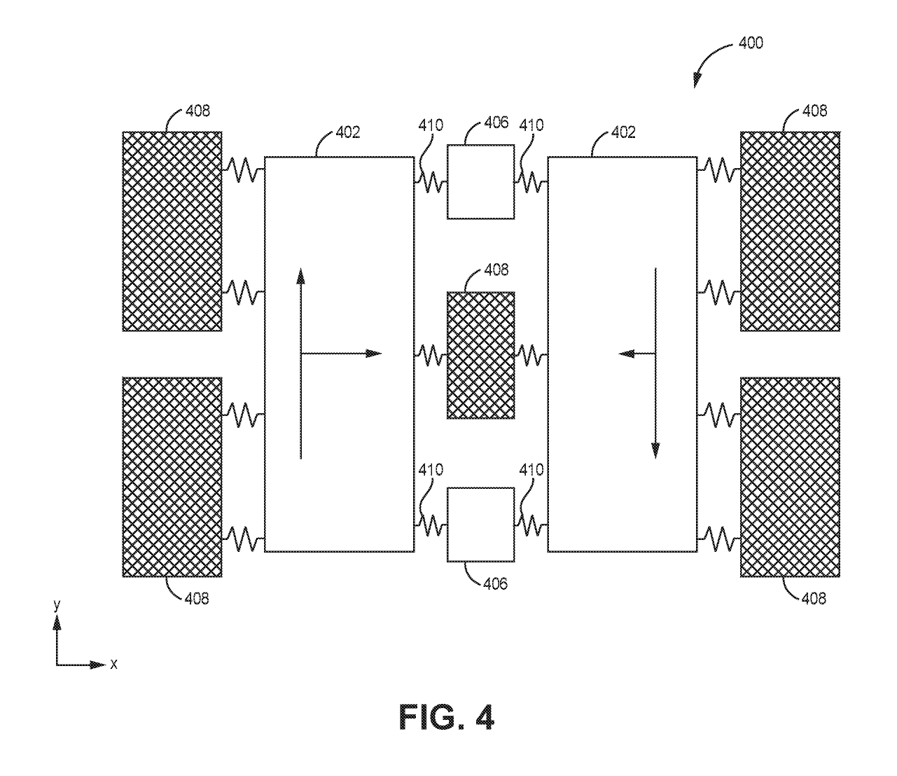

FIG. 4 is a diagram illustrating a MEMS sensor 400 having multiple tuned mass dampers 406. As illustrated, each of the proof masses 402 may be coupled to multiple tuned mass dampers 406 through flexures 410. This is in contrast to the single tuned mass damper 202 described in FIG. 2. As illustrated, a MEMS sensor may have any arrangement of tuned mass dampers that are able to reduce undesirable mechanical modes. Further, the proof masses 402 may also be coupled to anchors 408.

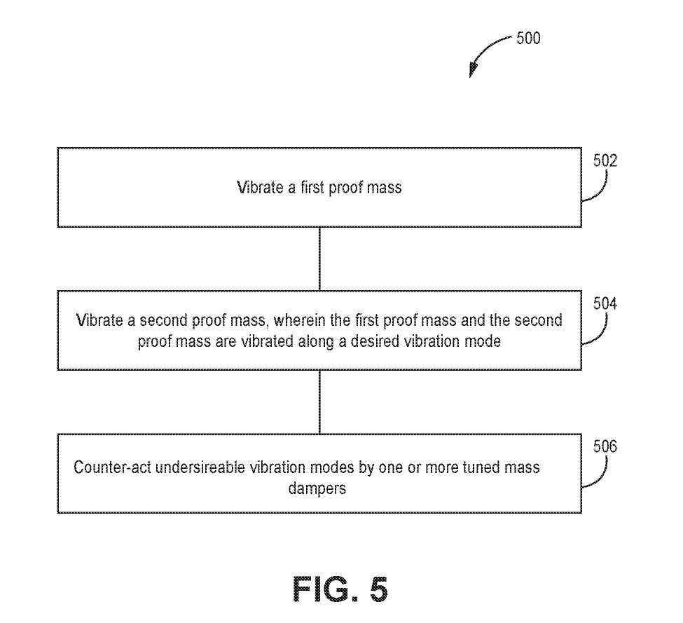

FIG. 5 is a flow diagram for a method 500 for suppressing undesirable vibration modes in a MEMS sensor. Method 500 proceeds at 502, where a first proof mass is vibrated. Method 500 then proceeds at 504, where a second proof mass is vibrated, wherein the first proof mass and the second proof mass are vibrated along a desired vibration mode. In at least one implementation, the first proof mass and the second proof mass are coupled to a substrate through a plurality of flexures and the first proof mass and the second proof mass are vibrated along desired vibration modes. Further, method 500 proceeds at 506, where undesirable vibration modes are counter-acted by a tuned mass damper. For example, the tuned mass damper may be coupled to the first proof mass and the second proof mass through flexures. Also, tuned mass dampers may be arranged along the perimeter of the MEMS sensor to counter-act rotational vibrations.

### Example Embodiments

Example 1 includes a system for suppressing undesirable vibration modes, the system comprising: a micro-electrical mechanical system (MEMS) resonator, the MEMS resonator comprising: two or more proof masses, comprising; and a plurality of anchors, wherein proof masses in the two or more proof masses are connected to the plurality of anchors through a plurality of flexures; a substrate, wherein the MEMS resonator is mounted to the substrate through the plurality of anchors; and one or more tuned mass dampers configured to counter-act the undesirable vibration modes in the substrate and the MEMS resonator.

Example 2 includes the system of Example 1, wherein the one or more tuned mass dampers are coupled to the substrate and the MEMS resonator is coupled to the substrate through separate flexures.

Example 3 includes the system of any of Examples 1-2, wherein the one or more tuned mass dampers counter-act rotational vibrations.

Example 4 includes the system of Example 3, wherein the rotational vibrations are counter-acted by one of the tuned mass dampers in the one or more tuned mass dampers that are located around a perimeter of the MEMS resonator.

Example 5 includes the system of any of Examples 1-4, wherein the one or more tuned mass dampers comprise a mass that is coupled to a first proof mass in the two or more proof masses through a first flexure and to a second proof mass in the two or more proof masses through a second flexure.

Example 6 includes the system of Example 5, wherein the one or more tuned mass dampers comprise a second mass that is coupled to the first proof mass through a third flexure and to the second proof mass through a fourth flexure.

Example 7 includes the system of any of Examples 1-6, wherein at least one tuned mass damper in the one or more tuned mass dampers is coupled to at least one anchor in the plurality of anchors.

Example 8 includes the system of any of Examples 1-7, wherein the MEMS resonator comprises at least one of: a dual mass tuning fork vibratory MEMS gyroscope; an out of plane gyroscope; an in plane gyroscope; and a vibrating beam accelerometer.

Example 9 includes a method for suppressing undesirable vibration modes in a micro-electrical mechanical sensor (MEMS) resonator, the method comprising: vibrating a first proof mass; vibrating a second proof mass, wherein the first proof mass and the second proof mass are coupled to a substrate through a plurality of flexures and the first proof mass and the second proof mass are vibrated along a desired vibration mode; and counter-acting undesirable vibration modes in at least one of the MEMS resonator and the substrate by one or more tuned mass dampers.

Example 10 includes the method of Example 9, wherein the one or more tuned mass dampers are coupled to the substrate and the MEMS resonator is coupled to the substrate through separate flexures.

Example 11 includes the method of any of Examples 9-10, wherein the undesirable vibration modes are rotational vibrations.

Example 12 includes the method of Example 11, wherein the rotational vibrations are counter-acted by at least one of the tuned mass dampers in the one or more tuned mass dampers that are located around a perimeter of the MEMS resonator.

Example 13 includes the method of any of Examples 9-12, wherein the one or more tuned mass dampers comprise a first mass that is coupled to the first proof mass through a first flexure and to the second proof mass through a second flexure.

Example 14 includes the method of Example 13, wherein the one or more tuned mass dampers comprise a second mass that is coupled to the first proof mass through a third flexure and to the second proof mass through a fourth flexure.

Example 15 includes the method of any of Examples 9-14, wherein a tuned mass damper in the one or more tuned mass dampers is coupled to at least one anchor in the plurality of anchors.

Example 16 includes the method of any of Examples 9-15, wherein the MEMS resonator comprises at least one of: a dual mass tuning fork vibratory MEMS gyroscope; an out of plane gyroscope; an in plane gyroscope; and a vibrating beam accelerometer.

Example 17 includes a system for suppressing undesirable vibration modes, the system comprising: a mounting fixture; a substrate mounted to the mounting fixture; a micro-electrical mechanical system (MEMS) sensor mounted to the substrate, the sensor comprising: a first proof mass; a second proof mass; and a plurality of anchors, wherein the first proof mass and the second proof mass are connected to the plurality of anchors through a plurality of flexures, wherein the MEMS sensor is mounted to the substrate through the plurality of anchors; and one or more tuned mass dampers configured to counter-act the undesirable vibration modes in the system.

Example 18 includes the system of Example 17, wherein the one or more tuned mass dampers are coupled to the substrate and the MEMS resonator is coupled to the substrate through separate flexures.

Example 19 includes the system of any of Examples 17-18, wherein the one or more tuned mass dampers counter-act rotational vibrations.

Example 20 includes the system of any of Examples 17-19, wherein the one or more tuned mass dampers comprise a first tuned mass damper that is coupled to the first proof mass through a first flexure and to the second proof mass through a second flexure.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A system for suppressing undesirable vibration modes, the system comprising:
a micro-electrical mechanical system (MEMS) resonator, the MEMS resonator comprising:
two or more proof masses, comprising; and
a plurality of anchors, wherein proof masses in the two or more proof masses are connected to the plurality of anchors through a plurality of flexures;
a substrate, wherein the MEMS resonator is mounted to the substrate through the plurality of anchors; and
one or more tuned mass dampers configured to counter-act the undesirable vibration modes in the substrate and the MEMS resonator.

2. The system of claim 1, wherein the one or more tuned mass dampers are coupled to the substrate and the MEMS resonator is coupled to the substrate through separate flexures.

3. The system of claim 1, wherein the one or more tuned mass dampers counter-act rotational vibrations.

4. The system of claim 3, wherein the rotational vibrations are counter-acted by one of the tuned mass dampers in the one or more tuned mass dampers that are located around a perimeter of the MEMS resonator.

5. The system of claim 1, wherein the one or more tuned mass dampers comprise a mass that is coupled to a first proof mass in the two or more proof masses through a first flexure and to a second proof mass in the two or more proof masses through a second flexure.

6. The system of claim 5, wherein the one or more tuned mass dampers comprise a second mass that is coupled to the first proof mass through a third flexure and to the second proof mass through a fourth flexure.

7. The system of claim 1, wherein at least one tuned mass damper in the one or more tuned mass dampers is coupled to at least one anchor in the plurality of anchors.

8. The system of claim 1, wherein the MEMS resonator comprises at least one of:
a dual mass tuning fork vibratory MEMS gyroscope;
an out of plane gyroscope;
an in plane gyroscope; and
a vibrating beam accelerometer.

9. A method for suppressing undesirable vibration modes in a micro-electrical mechanical sensor (MEMS) resonator, the method comprising:
vibrating a first proof mass;
vibrating a second proof mass, wherein the first proof mass and the second proof mass are coupled to a substrate through a plurality of flexures and the first proof mass and the second proof mass are vibrated along a desired vibration mode; and
counter-acting undesirable vibration modes in at least one of the MEMS resonator and the substrate by one or more tuned mass dampers.

10. The method of claim 9, wherein the one or more tuned mass dampers are coupled to the substrate and the MEMS resonator is coupled to the substrate through separate flexures.

11. The method of claim 9, wherein the undesirable vibration modes are rotational vibrations.

12. The method of claim 11, wherein the rotational vibrations are counter-acted by at least one of the tuned mass dampers in the one or more tuned mass dampers that are located around a perimeter of the MEMS resonator.

13. The method of claim 9, wherein the one or more tuned mass dampers comprise a first mass that is coupled to the first proof mass through a first flexure and to the second proof mass through a second flexure.

14. The method of claim 13, wherein the one or more tuned mass dampers comprise a second mass that is coupled to the first proof mass through a third flexure and to the second proof mass through a fourth flexure.

15. The method of claim 9, wherein a tuned mass damper in the one or more tuned mass dampers is coupled to at least one anchor in the plurality of anchors.

16. The method of claim 9, wherein the MEMS resonator comprises at least one of:
a dual mass tuning fork vibratory MEMS gyroscope;
an out of plane gyroscope;
an in plane gyroscope; and
a vibrating beam accelerometer.

17. A system for suppressing undesirable vibration modes, the system comprising:
a mounting fixture;
a substrate mounted to the mounting fixture;
a micro-electrical mechanical system (MEMS) sensor mounted to the substrate, the sensor comprising:
a first proof mass;
a second proof mass; and
a plurality of anchors, wherein the first proof mass and the second proof mass are connected to the plurality of anchors through a plurality of flexures, wherein the MEMS sensor is mounted to the substrate through the plurality of anchors; and
one or more tuned mass dampers configured to counter-act the undesirable vibration modes in the system.

18. The system of claim 17, wherein the one or more tuned mass dampers are coupled to the substrate and the MEMS resonator is coupled to the substrate through separate flexures.

19. The system of claim 17, wherein the one or more tuned mass dampers counter-act rotational vibrations.

20. The system of claim 17, wherein the one or more tuned mass dampers comprise a first tuned mass damper that is coupled to the first proof mass through a first flexure and to the second proof mass through a second flexure.
